(19) United States
(12) Patent Application Publication
(10) Pub. No.: US 2015/0309539 A1
(43) Pub. Date: Oct. 29, 2015

(54) Information Handling System Housing Synchronization with Differential Torque Hinge

(71) Applicant: Dell Products L.P., Round Rock, TX (US)

(72) Inventors: Kevin L. Kamphuis, Round Rock, TX (US); Daniel Coolidge, Pflugerville, TX (US)

(73) Assignee: Dell Products L.P., Round Rock, TX (US)

(21) Appl. No.: 14/261,806

(22) Filed: Apr. 25, 2014

(51) Int. Cl. G06F 1/16; E05D 11/08; E05D 5/02

(52) U.S. Cl. CPC G06F 1/1681; E05D 5/02; E05D 11/08; G06F 1/1616

(57) ABSTRACT

An information handling system hinge assembly simulates synchronous and other types of motions by applying friction varied based upon dual-axis hinge rotational position to generate differential torque at an information handling system chassis and lid portion. A connecting device maintains first and second hinges in position relative to each other during rotation of the chassis and lid portions, such as through 360 degrees of rotation between closed and tablet positions.

### BACKGROUND OF THE INVENTION

1. Field of the Invention

The present invention relates in general to the field of information handling system convertible housings, and more particularly to information handling system housing synchronization with a differential torque hinge.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Portable information handling systems are built in housings having a variety of configurations. A traditional clamshell configuration has a lid rotationally coupled to a main chassis portion so that the lid articulates between open and closed positions. In the open position, the lid rotates approximately 90 degrees to expose a display that presents visual information provided by processing components disposed in the main chassis portion. In the closed position, the lid rotates to bring the display against the main chassis portion to provide portability. Although conventional clamshell configurations provide ease of use and convenience, the lid generally does not offer a firm enough platform for accepting touchscreen inputs. For this and other reasons, portable information handling systems that include a touchscreen display in an articulating lid generally provide rotation to a tablet-type of configuration, which supports the lid against the main housing with the display exposed and stationary during touch interfaces. For example, one option is to rotate the lid from the closed position for 360 degrees so that the display is exposed like a tablet and resting against the bottom surface of the main chassis portion.

One difficulty with rotating a lid completely around a chassis portion is that the hinge supporting the rotation has to have adequate spacing to rotate the lid around the main chassis portion from a planar relationship in the closed position to a planar relationship in the open position. Generally, a two-axis hinge provides a reduced footprint at the information handling system housing relative to a single axis hinge. Generally, when using a two axis hinge, one axis substantially aligns with the lid and the other with the chassis portion so that the lid rotates around the chassis portion between a closed position parallel to the top of the chassis portion and a tablet position parallel to the bottom of the chassis portion. In order to provide a smooth motion as the hinge axes rotate relative to each other, a synchronization mechanism is sometimes included with the hinge to synchronize the motion of the axes relative to each other. One common synchronization mechanism is a set of gears that interact to translate motion from one axis to the other axis. An alternative approach to managing the relative motion of the axes to each other is to move one axis at a time by inhibiting the other axis.

Although synchronization mechanisms provide smooth and predictable motion of the axles of a dual axis hinge relative to each other, in small footprint mobile systems the synchronization mechanisms often include small components that are subject to breakage. As an example, if a set of gears become out of synchronization with each other, the lid can become out of alignment with the chassis portion to appear cockeyed and to move in an unnatural manner. Significant misalignment can make the information handling system essentially unusable, such as when gears fail to mesh or when gears bind and cease up.

### SUMMARY OF THE INVENTION

Therefore a need has arisen for a system and method which rotates a dual axis hinge with desired relative motion without synchronizing structures that drive motion between axes.

In accordance with the present invention, a system and method are provided which substantially reduce the disadvantages and problems associated with previous methods and systems for synchronizing motion of dual axis hinges. One or more friction members provide varying friction to each axle of a dual axis hinge based at least in part upon the rotational position of the hinge to provide a desired behavior, such as a simulated synchronized gear or sequential axis behavior.

More specifically, an information handling system is built with plural processing components disposed in a chassis and operable to cooperate to process information. The chassis rotationally couples with a lid that supports a display for presenting information as visual images. A hinge assembly couples the lid and chassis to have dual axis motion that allows the lid to rotate 360 degrees between a closed position and a tablet position. In order provide a desired motion of the lid relative to the hinge, one or more friction members engage with the axles that support rotation of the lid and hinge to vary friction applied to each axle based upon rotational position relative to each axle. For example, friction members vary friction to produce differential torque at the axles so that motion about the axles simulates motion of a geared synchronized dual axis hinge. As another example, differential torque applied sequentially at each axle simulates a detent-type sequential motion dual axis hinge. A connector device disposed between opposite sides of a hinge assembly helps to maintain a synchronized motion of the hinges relative to each other.

The present invention provides a number of important technical advantages. One example of an important technical advantage is that different types of relative motions at a dual axis hinge are provided by using variable friction members to generate differential torque that simulate more expensive and complex hinge mechanisms. For example, changing friction at each axle during rotation allows simulation of a dual axis gear-synchronized hinge or a dual axis detent synchronized hinge by providing the end user with the desired motion and feel. Friction elements adjust to wear over time for a consistent end user experience, provide a robust solution that is less likely to break, and offer an end user with an option of overcoming the differential torque to obtain different types of motions if the end user desires.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a perspective blown-up view of a portable information handling system having a dual-axis hinge assembly synchronized with differential torque;

FIG. 2 depicts a perspective view of an example embodiment information handling system having plural hinges in a hinge assembly;

FIG. 3 depicts a perspective view of an example hinge assembly having a hinge cover to coordinate motion of dual hinges;

FIG. 4 depicts a perspective view of an example hinge assembly having frictional elements to provide predetermined coordinated hinge movement;

FIG. 5 depicts an example embodiment with differential torque coordinated simulation of sequential axis rotation;

FIG. 6 depicts an example embodiment with differential torque coordinated simulation of gear-driven synchronized axis rotation;

FIG. 7 depicts a graphical representation of differential torque coordinated simulation of sequential axis motion;

FIG. 8 depicts a side view of a wrapped band differential friction generation device;

FIG. 9 depicts a side view of a clip-style differential friction generation device;

FIG. 10A-10B depicts a compression disk differential friction generation device in a low torque position;

FIG. 11A-11B depicts a compression disk differential friction generation device in a high torque position;

FIG. 12 depicts a physical connector device coupled between hinge elements to coordinate synchronized motion of a hinge; and

FIG. 13 depicts a dual element physical connector device coupled between hinge elements to coordinate synchronized motion of a hinge.

### DETAILED DESCRIPTION

A differential torque hinge assembly coordinates dual axis motion of an information handling system lid about a chassis to simulate motion provided by more complex hinge mechanisms. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

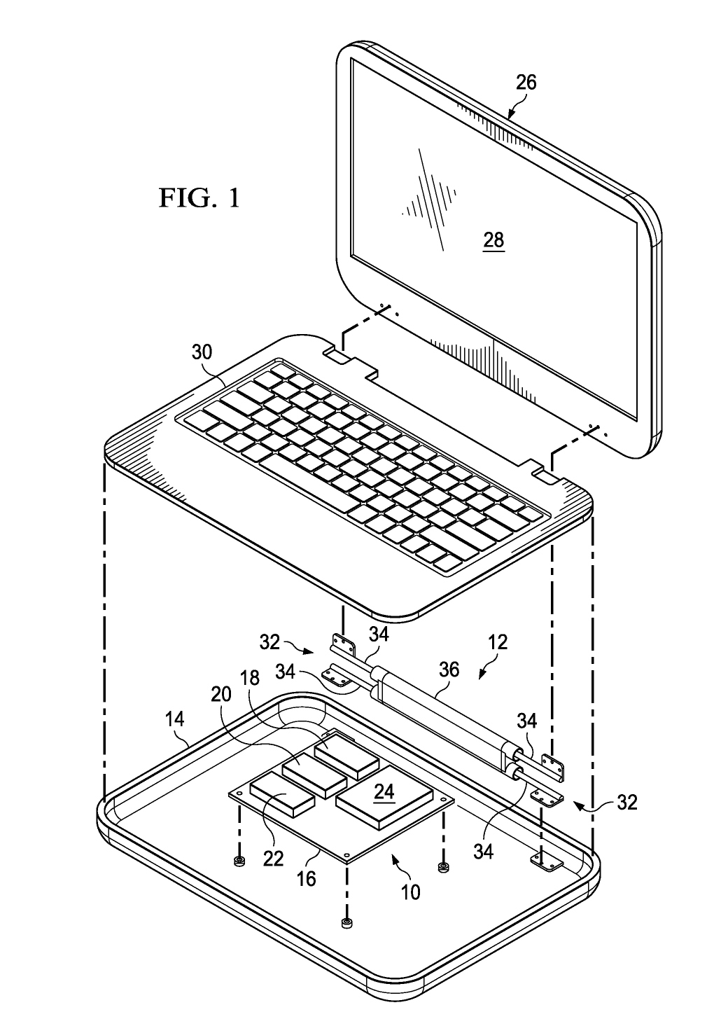

Referring now to FIG. 1, a perspective blown-up view depicts a portable information handling system 10 having a dual-axis hinge assembly 12 synchronized with differential torque. Information handling system 10 has a chassis portion 14 that contains processing components for processing information, such as motherboard 16 that supports a CPU 18, RAM 20, a solid state drive 22 and a chipset 24. Hinge assembly 12 rotationally couples chassis portion 14 to a lid portion 26 that supports a display 28 for presenting information as visual images. A keyboard 30 assembles over the processing components disposed in chassis 14 to accept end user inputs. In addition, display 28 includes a touchscreen that accepts end user inputs as touches at display 28. Hinge assembly 12 rotates lid 26 between a closed position with display 28 proximate keyboard 30 and an open position with display 28 upright and keyboard 30 exposed.

In order to provide a more convenient platform for an end user to make touch inputs at display 28, hinge assembly 12 rotates substantially 360 degrees so that display 28 is exposed in a tablet position. Hinge assembly 12 has first and second hinges 32 that each couple to lid 26 and chassis 14. First and second parallel axles 34 extend between first and second hinges 32 and rotate relative to each other in a dual axis relationship. A connector device 36 helps to maintain a positional relationship between hinges 32. The dual axis rotational relationship provided by hinge assembly 12 allows lid portion 26 to rest substantially parallel to chassis portion 14 both when proximate keyboard 30 in the closed position and when on the bottom of chassis 14 in the tablet position.

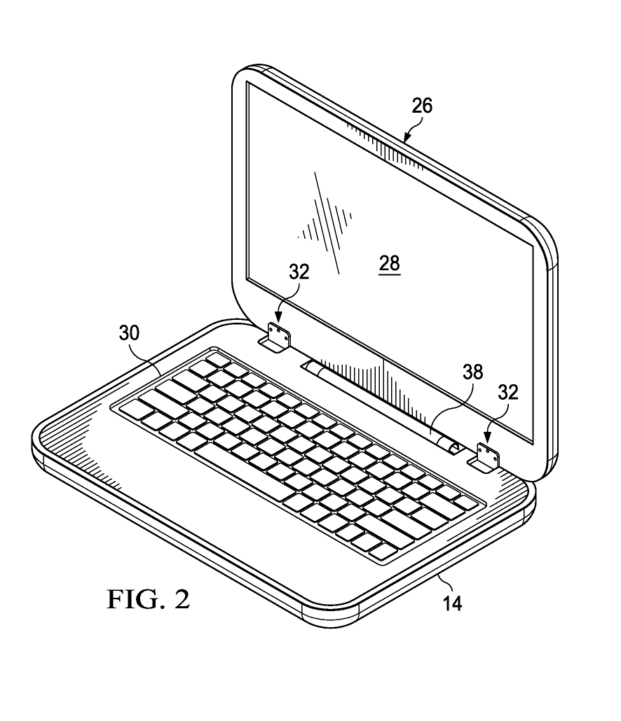

Referring now to FIG. 2, a perspective view depicts an example embodiment information handling system having plural hinges 32 in a hinge assembly 12. In the example embodiment, lid 26 is rotated approximately 90 degrees from closed to a clamshell position relative to chassis 14 so that keyboard 30 is exposed. A hinge 32 is located on substantially opposing sides of chassis 14 and lid 26 and a friction member 38 is disposed between hinges 32 to manage motion about the dual axles of hinges 32. In alternative embodiments, friction member 38 may be integrated into each hinge 32 or may be included in a connecting portion extending between each hinge 32. Friction member 38 applies varying degrees of friction at each axle during rotation so the motion of lid 26 relative to chassis 14 simulates motion provided by other types of synchronizing mechanisms, such as gears or detents. For example, friction member 38 increases friction applied to an axle if the axle rotates a greater degree than its parallel axle so that the axles rotate substantially in synchronization with each other similar to rotation provided by a gear interaction between the axles. As another example, friction applied to one axle is greater than the other so that motion of the lid relative to the chassis mimics that provided by a detent that holds each axle still in sequence. In another example, friction changes based upon the direction of rotation of an axis.

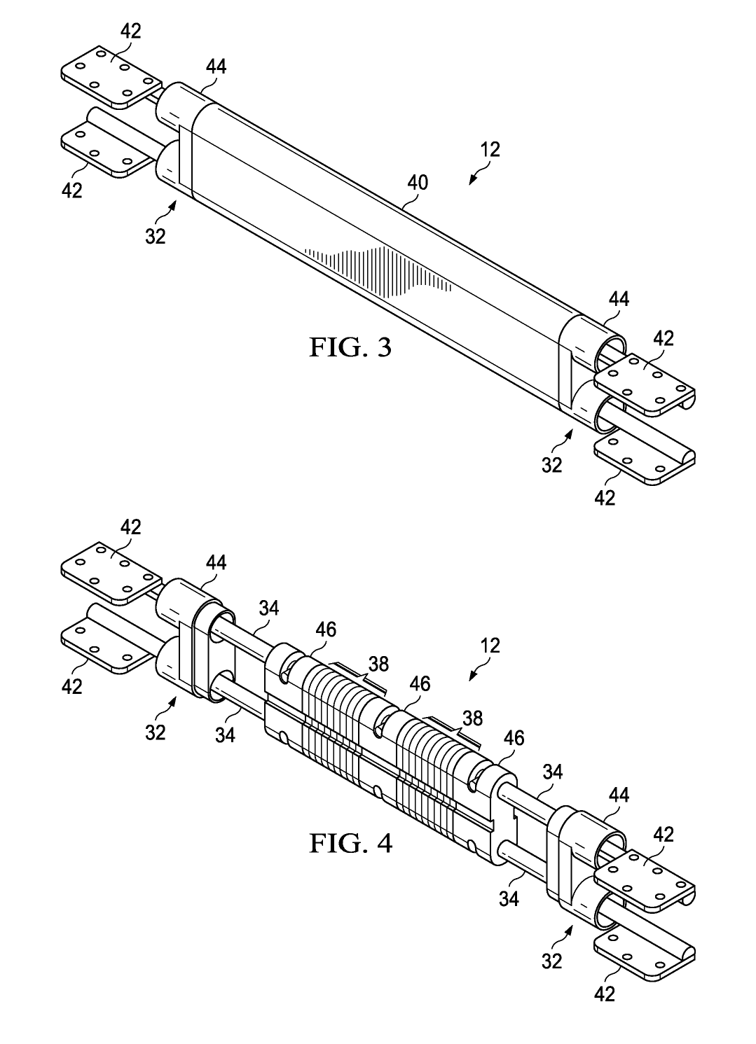

Referring now to FIG. 3, a perspective view depicts an example hinge assembly 12 having a hinge cover 40 to coordinate motion of dual hinges 32. Mounting brackets 42 secure each hinge 32 to lid and chassis coupling points. A wire cover 44 guides wires through hinge assembly 12 to provide communication between processing components in the chassis and a display in the lid. Hinge cover 40 supports alignment of hinges 32 in relative rotation so that the dual axles do not over or under rotate relative to each other, thus throwing the lid and chassis out of sequence. Although hinge cover 40 might allow greater rotation about one axle than the other, the rotation of one axle is maintained relatively in alignment.

Referring now to FIG. 4, a perspective view depicts an example hinge assembly 12 having frictional elements 38 to provide predetermined coordinated hinge movement. In the example embodiment, frictional elements 38 provide a similar function to hinge cover 40 in keeping the axles in relative alignment with each other so that a hinge 32 on one side does not over rotate relative to the hinge on the other side. Rotation stops associated with each axle 34 interact with an opening in frictional elements 38 to limit rotation about each axle, thus protecting the chassis and lid from applying too much force against each other. As is set forth in greater detail below, frictional elements 38 vary friction with rotation angle about each axis or rotation direction about each axis to provide a desired rotational behavior, such as imitation of gear-synchronized or detent-managed sequential movement of a lid relative to a chassis.

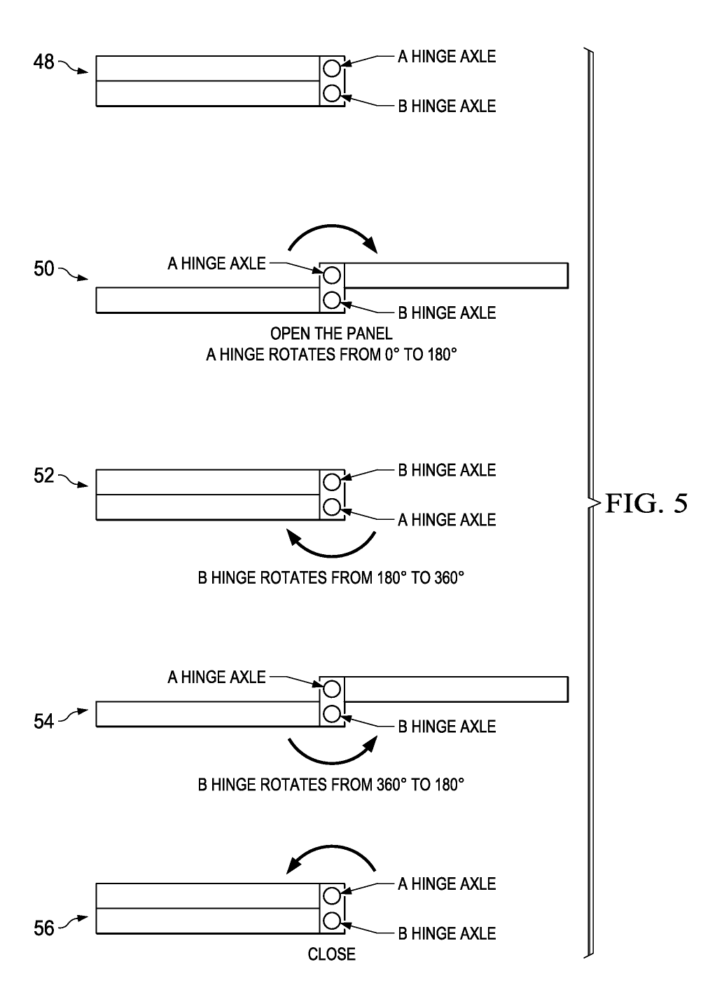

Referring now to FIG. 5, an example embodiment depicts differential torque coordinated simulation of sequential axis rotation. At position 48, the two portions are in a closed position with the A hinge axle having a reduced friction relative to the B hinge axle. At position 50, the A portion rotates 180 degrees with movement about the A hinge axle having reduced torque relative to movement about the B hinge axle so that, absent intentional increased torque applied for rotation about the B hinge axle, movement is provided only about the A hinge axle. Once the friction member allows for rotation of 180 degrees at step 50, the relative friction applied to the B hinge axle decreases and the relative friction applied to the A hinge axle increases, so that rotation occurs about the B hinge axle to step 52. At step 52, friction remains relatively reduced for the B hinge axle relative to the A hinge axle through step 54, and then shifts again to have greater friction at the B hinge axle than the A hinge axle through step 56. In an alternative embodiment, simulated sequential rotation of one axis followed by the other may be simulated so that the same axis initiates rotation first. For example, in the example of FIG. 5, hinge A may be set to initiate rotation before hinge B when rotation is started in both the closed and tablet positions by having torque generated by friction at hinge A set to a lower value than torque generated by hinge B. As another example, friction may be set based upon a direction of rotation of one axis relative to each other, such as by having friction set higher on hinge A relative to hinge B in a first rotation direction and higher on hinge B relative to hinge A in a second rotation of axis. Friction-induced torque may be set with a compression disk variable friction as described below, by adding more length to increase surface area on a wrap band style hinge, or by adding clips to increase surface area on a clip style hinge. Although differential torque created by changes in friction based upon rotation position simulates a sequential axis rotation, an end user can apply different torque at each axle to overcome the differential friction and obtain an alignment of the two portions that the end user desires.

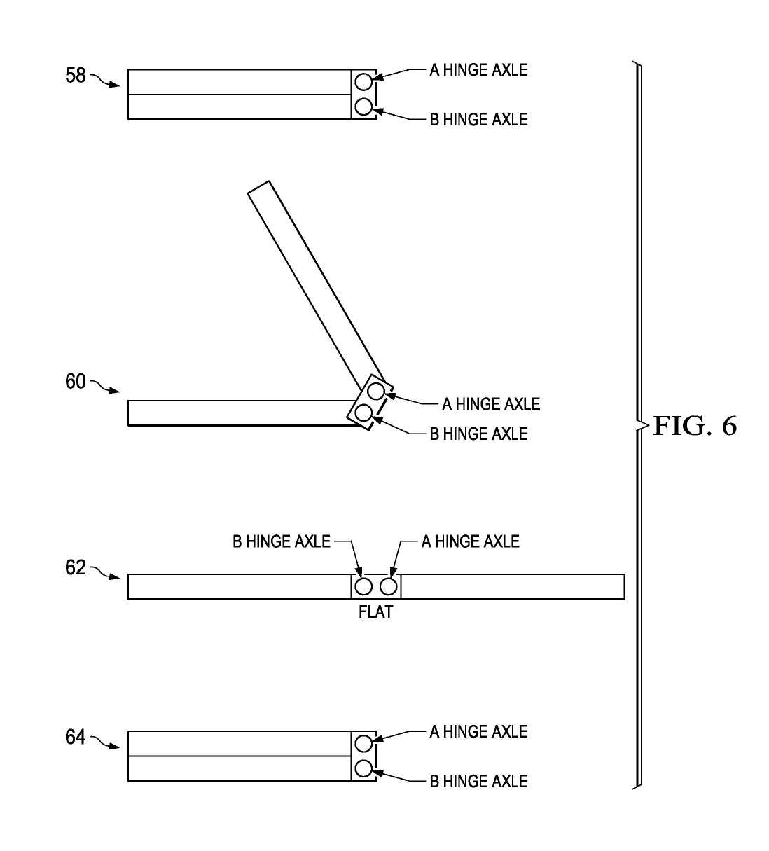

Referring now to FIG. 6, an example embodiment depicts differential torque coordinated simulation of gear-driven synchronized axis rotation. At step 58 both axles have similar friction working against rotation. At step 60, both axles rotate synchronously to move at substantially the same rate relative to each other so that, at step 62 the two portions lay flat relative to each other. At step 64, rotation in the opposite direction returns the information handling system to a closed position, while continued rotation in the same direction results in a tablet position. In one embodiment, slightly increasing friction in the direction of rotation on both axles aids maintenance of synchronous rotation since over rotation at one axle increases friction at that axle so that the other axle turns at greater rate in response to relatively reduced friction.

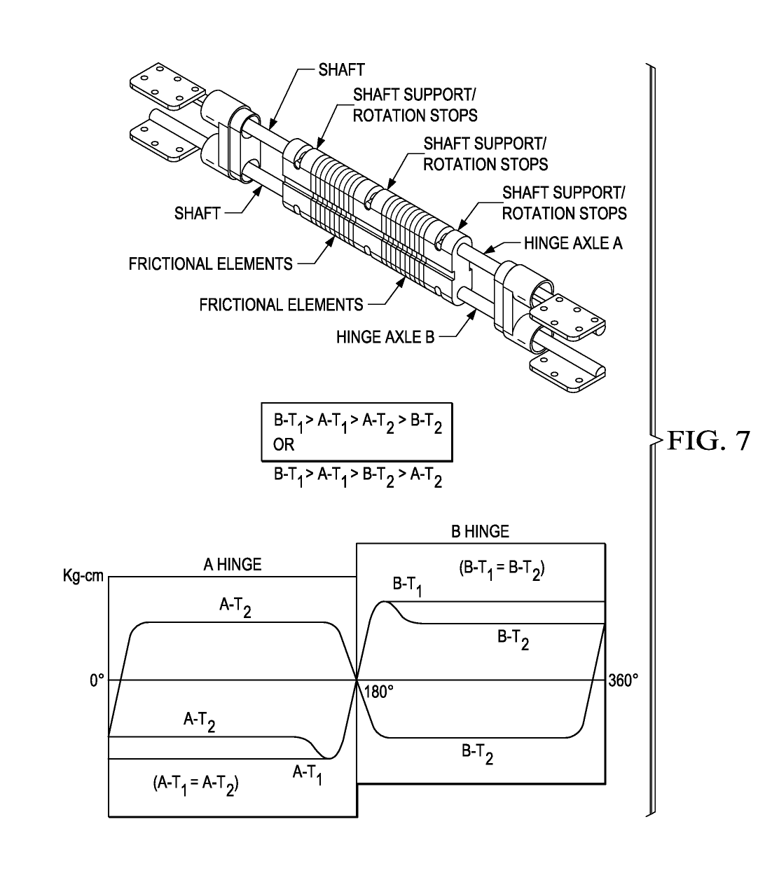

Referring now to FIG. 7, a graphical representation depicts differential torque coordinated simulation of sequential axis motion. The Y-axis depicts torque versus rotational position on the X-axis. Through the first 180 degrees of rotation, the B hinge axle has increased friction relative to the A hinge axle so that rotation occurs at the A hinge axle in both directions of rotational movement. From 180 to 360 degrees of rotation, the A hinge axle has increased friction relative to the B hinge axle so that rotation occurs at the B hinge axle in both directions of rotational movement. The result is simulation of a detent-type hinge that allows rotational movement about only one axle at a time. Advantageously, an end user can choose to overcome the simulated detent-type hinge movement if desired by overcoming the frictional force on the axle having the greater friction. Simulation of the detent with friction reduces design and manufacture costs by reducing the interaction of moving parts in the small footprint available in a typical portable information handling system.

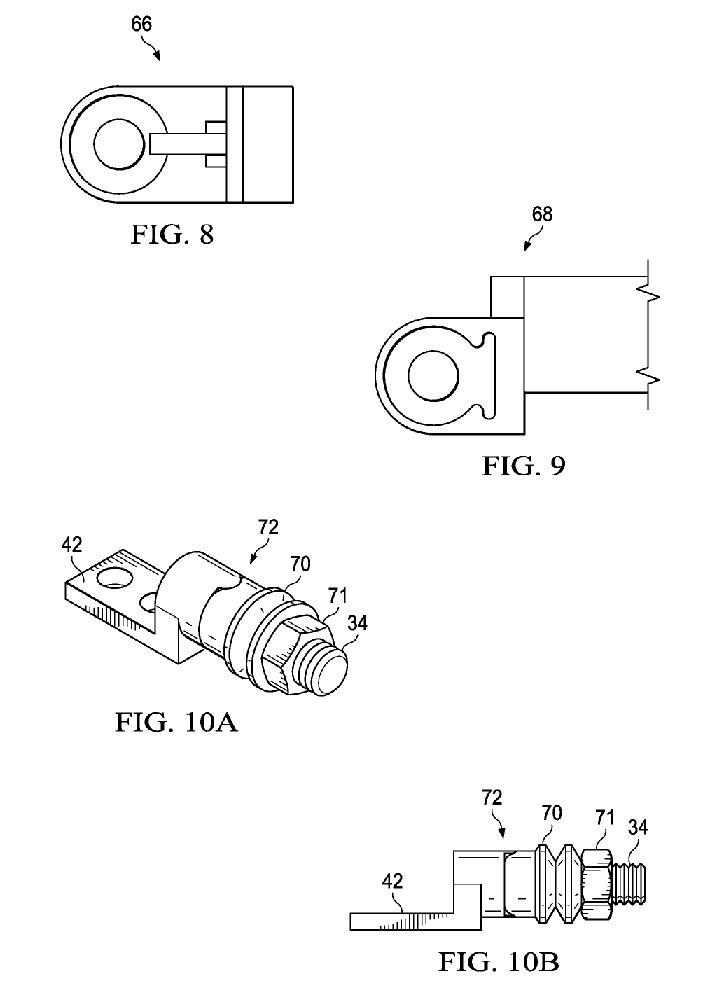

Referring now to FIG. 8, a side view depicts a wrapped band differential friction generation device 66. An arm pushes into the axle to provide friction that resists movement. The amount of friction may be varied by varying the force at which the arm presses against the axle, or by varying the diameter of the axle as it rotates past the arm, such as with a cam built on the axle. Referring now to FIG. 9, a side view depicts a clip-style differential friction generation device 68. The clip presses on the axle to generate friction that resists movement. The amount of friction may be varied by varying the force at which the clip presses against the axle, or by varying the diameter of the axle proximate to the clip, such as by including a cam.

Referring now to FIG. 10A-10B, a compression disk differential friction generation device is depicted in a low torque position. Compression disks 70 are disposed on axle 34 to induce friction against rotation of axle 34 within the inner diameter of compression disks 70. The greater that compressive force placed upon compression disks 70, the greater the friction provided by compression disks 70 against the rotation of axle 34. A compression ramp 72 engages with mounting bracket 42 to set the compressive force applied along the axis of axle 34 to compression disks 70 and against a fixed nut 71. In FIG. 10A-10B, the compressive force applied by compressive ramp 72 against compression disks 70 is at the lowest setting because an extension from mounting bracket 42 engages a detent formed in compression ramp 72.

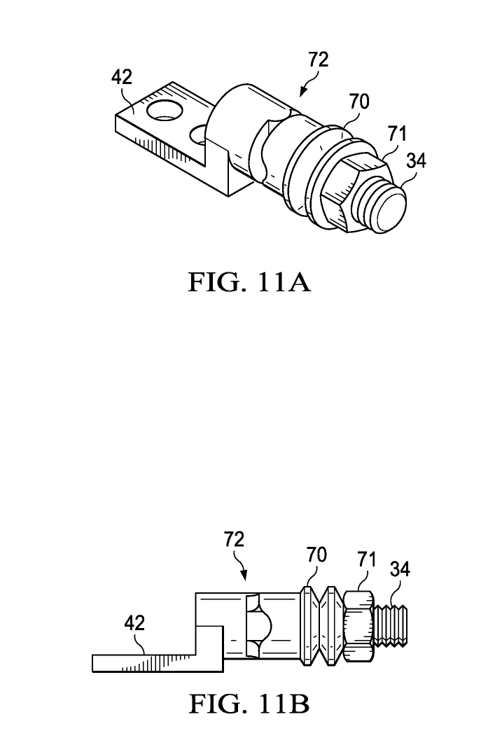

Referring now to FIG. 11A-11B, a compression disk differential friction generation device is depicted in a high torque position. As axle 34 rotates relative to mounting bracket 42, compression ramp 72 turns with axle 34 so that an increased compressive force is placed against compression disks 70. In the depiction of FIG. 11A-11B, the compressive disks 70 are in a high torque position with the extension of mounting bracket 42 rotated out of the detent of compression ramp 72. As axle 34 rotates, torque provided by the compression disks 70 increases until the position depicted by FIG. 11A-11B is reached, after which torque decreases with rotation of the detent relative to the mounting bracket. In one embodiment, sequential movement of axles in a dual axis hinge is provided by aligning the mounting bracket detent and compression ramp so that one axis has high friction at a time. For example, the axle with the relatively low friction position will rotate until it reaches a stop, after which the other axle will rotate. In another embodiment, changing torque with rotation as both axles transition from a low to high torque position encourages synchronized motion of both axles with each other to simulate a gear-synchronized dual axis hinge. For instance, as one axis over rotates relative to the other, the increased torque needed to continue rotation of the over-rotated axle results in an increased rotation about the other axle, which has less torque working against its rotation. In such an embodiment, a reset to the low torque position depicted by FIG. 10A-10B may be accomplished upon a stop in rotation, such as with a spring action, rather than based upon rotational position.

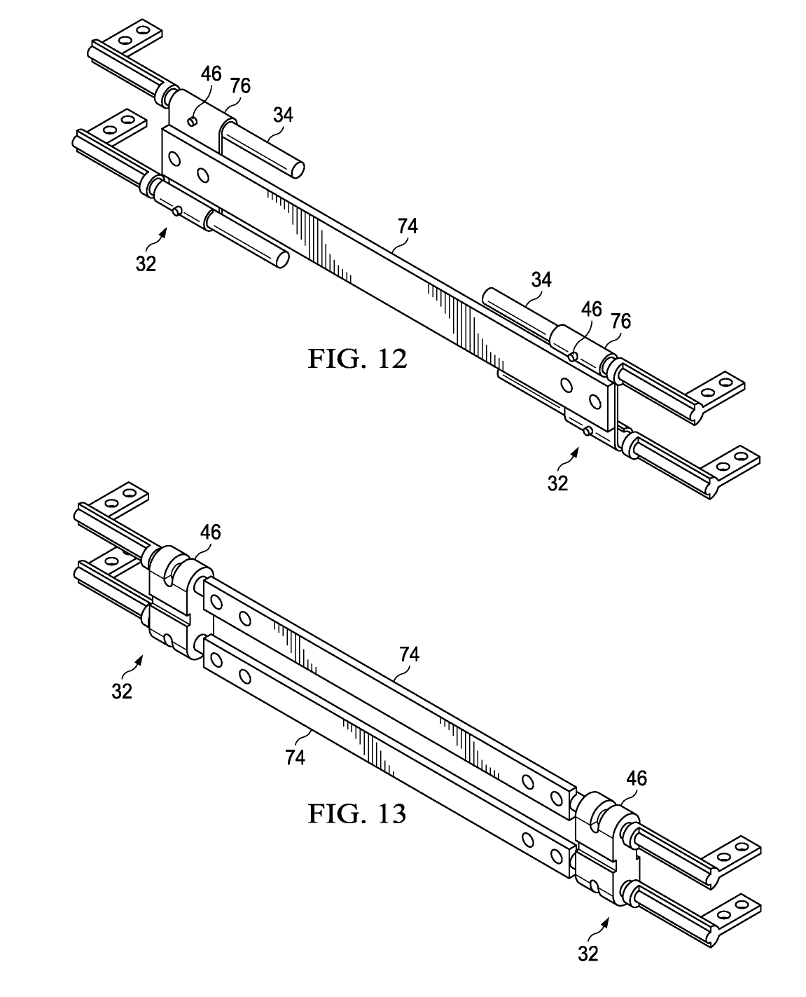

Referring now to FIG. 12, a physical connector device 74 is depicted coupled between hinges 32 to coordinate synchronized motion of a hinge assembly 12. Connector 74 is a solid material, such as aluminum or plastic, which couples to hinges 32 located at opposing sides of hinge assembly 12 to maintain the hinges in position relative to each other. A slider element 76 couples at each end of connector 74 and has an opening aligned with each axis of the hinge assembly, each opening accepting an axle 34. Connector 74 and sliders 76 move as a solid unit to maintain the relative position of axles 34 in the approximate range of what a synchronized hinge would provide. Axles 34 rotate within each slider but are maintained in position relative to each other by the lid or chassis coupled to both bracket connector ends. In order to manage movement of the axles 34 of each axis, such as with synchronized or sequential movement, friction members are associated with at least one axle of each axis. For example, compression disks like those depicted in FIG. 11A-11B provide varying friction based upon rotational position so that differential torque simulates a desired type of dual axis motion.

Referring now to FIG. 13, a dual element physical connector device 74 is depicted coupled between hinge elements to coordinate synchronized motion of a hinge assembly. In the example embodiment, each of the dual elements of connector 74 align substantially with a rotation axis of hinges 32. Rotation stops located in hinges 32 aid in limiting the risk of over rotation of the lid and chassis portions relative to each other. Using dual elements in connector 74 reduces overall system weight and provides addition room and support for adding friction members that provide differential torque based upon rotation position.

Although the present invention has been described in detail, it should be understood that various changes, substitutions and alterations can be made hereto without departing from the spirit and scope of the invention as defined by the appended claims.

What is claimed is:

1. An information handling system comprising:
a chassis;
processing components disposed in the chassis and operable to process information;
a lid;
a display disposed in the lid and interfaced with the processing components, the display operable to present the information as visual images;
first and second hinges rotationally coupling the chassis and lid, each hinge having first and second axles;
a first friction member associated with the first hinge; and
a second friction member associated with the second hinge;
wherein the first and second friction members change torque at the first and second axles based upon an angle of rotation of the chassis relative to the lid to create a predetermined rotational behavior of the chassis relative to the lid.

2. The information handling system of claim 1 wherein the predetermined rotational behavior comprises simulation of a synchronized gear motion of the chassis relative to the lid.

3. The information handling system of claim 1 further comprising a physical connector device coupling the first axle of the first hinge relative to the first axle of the second hinge, and coupling the second axle of the first hinge relative to the second axle of the second hinge.

4. The information handling system of claim 3 wherein the physical connector device comprises a hinge cover that covers at least a portion of a length between the first and second hinges.

5. The information handling system of claim 3 wherein the physical connector device comprises a single bar that couples at one end to the first and second axles of the first hinge and couples at a second end to the first and second axles of the second hinge.

6. The information handling system of claim 3 wherein the physical connector device comprises a first bar that couples the first axle of the first hinge to the first axle of the of the second hinge and a second bar that couples the second axle of the first hinge to the second axle of the second hinge.

7. The information handling system of claim 1 wherein the first and second friction members comprise compression disks disposed on each axle and a ramp disposed at a rotation point of each axle, the ramp varying compression of the compression disks, the compression varying torque associated with rotation of each axle.

8. The information handling system of claim 1 wherein the predetermined rotational behavior comprises simulation of sequential axis rotation and wherein the first and second friction members change torque at the first and second axles based upon direction of rotation.

9. A method for rotating an information handling system lid portion relative to a chassis portion, the method comprising:
coupling first and second hinges to the lid portion and the chassis portion, each hinge providing rotation about first and second axles disposed along first and second axes;
applying friction to the first and second axles with friction members, the friction resisting rotation of the first and second axles, the friction varying based upon the rotational position of the chassis and lid in order to create a predetermined rotational behavior.

10. The method of claim 9 wherein the predetermined rotational behavior comprises simulation of synchronized gear motion between the lid portion and chassis portion.

11. The method of claim 9 wherein the predetermined rotational behavior comprises simulation of sequential axis rotation between the lid portion and chassis portion.

12. The method of claim 9 further comprising coordinating motion of the first and second hinges with a connecting member coupled to the first and second hinges.

13. The method of claim 12 wherein the connecting member comprises a housing extending between the first and second hinges that covers the first and second hinges.

14. The method of claim 9 wherein applying friction to the first and second axles with friction members, the friction resisting rotation of the first and second axles, the friction varying based upon the rotational position of the chassis and lid in order to create a predetermined rotational behavior further comprises:
applying the friction by compressing disks disposed about each axle; and
varying the friction by varying a compressive force applied to the disks based upon the position of each axle.

15. The method of claim 14 wherein varying the friction by varying a compressive force applied to the disks based upon the position of each axle further comprises engaging a ramp with each axle at an axle rotation point, the ramp changing the position of the axle relative to the compressing disks to vary the compressive force applied by the disks.

16. The method of claim 9 wherein applying friction to the first and second axles with friction members, the friction resisting rotation of the first and second axles, the friction varying based upon the rotational position of the chassis and lid in order to create a predetermined rotational behavior, further comprises:
applying friction by pressing a friction member against each axle; and
varying the friction by varying the diameter around the axle proximate the friction member.

17. A hinge assembly comprising:
attachment devices operable to couple the hinge assembly between an information handling system chassis portion and lid portion;
first and second hinges coupled to the attachment devices, each of the first and second hinges having first and second axles;
plural friction members, at least one of the plural friction members applying friction at each the first and second axles of each hinge, the friction varying based upon a rotational position and a direction of rotation of each of the first and second axles of each hinge so that the first and second hinges provide a predetermined rotational behavior of the chassis portion relative to the lid portion.

18. The hinge assembly of claim 17 wherein the predetermined rotational behavior comprises simulation of synchronized gear motion between the lid portion and chassis portion.

19. The hinge assembly of claim 17 wherein the predetermined rotational behavior comprises simulation of sequential axis rotation between the lid portion and chassis portion.

20. The hinge assembly of claim 17 wherein the plural friction members comprise compression disks that increase friction when compressed and decrease friction when decompressed, the compression disks compressed and decompressed based upon a rotational position of the hinges.
